(19) United States
(12) Patent Application Publication
(10) Pub. No.: US 2023/0388734 A1
(43) Pub. Date: Nov. 30, 2023

(54) Spatial Audio Rendering

(71) Applicant: Nokia Technologies Oy, Espoo (FI)

(72) Inventors: Sujeet Shyamsundar MATE, Tampere (FI); Mikko-Ville LAITINEN, Espoo (FI)

(21) Appl. No.: 18/027,728

(22) PCT Filed: Aug. 30, 2021
(86) PCT No.: PCT/FI2021/050580

§ 371 Date: Mar. 22, 2023

(30) Foreign Application Priority Data
Sep. 23, 2020 (GB) 2015020.7

(51) Int. Cl. H04S 7/00; H04S 3/00

(52) U.S. Cl. CPC H04S 7/303; H04S 3/008; H04S 2400/11; H04S 2420/11; H04S 2400/01

(57) ABSTRACT

Apparatuses, systems, methods, and computer programs enable spatial audio rendering that allows for six degrees of freedom of movement of a listener. The spatial audio comprises higher order ambisonic signals. An apparatus includes circuitry for generating audio signal content sets that provide spatial audio scenes; determining positions in which the spatial audio scenes are audible; and associating a subset of audio signal content sets with the determined positions such that a first subset of audio signal content sets is associated with a first position and a second subset of audio signal content sets is associated with a second position. When audio signal content is provided for rendering, the first subset of audio signal content sets is retrieved if the listener is at the first position and if the listener is at the second position the second subset of audio signal content sets is retrieved.

### TECHNOLOGICAL FIELD

Examples of the disclosure relate to spatial audio rendering. Some relate to spatial audio rendering that allow for six degrees of freedom of movement of a listener.

### BACKGROUND

Audio signal sets, such as Higher Order Ambisonics (HOAs) can be used to enable spatial rendering of a listening space. This can enable a listener to perceive accurate spatial aspects of audio scenes within the listening space. Such systems can be computationally intensive and can require large bandwidth for the transmission of the audio signals.

### BRIEF SUMMARY

According to various, but not necessarily all, examples of the disclosure there is provided an apparatus comprising means for: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener if the listener is at the first position the first subset of audio signal content sets is retrieved and if the listener is at the second position the second subset of audio signal content sets is retrieved.

The audio signal content sets may comprise at least one of: two or more audio channels; one or more audio channels and metadata corresponding to the one or more audio channels.

The audio signal content sets may be configured to be provided in data structures comprising the audio channel data and associated rendering metadata.

A plurality of data structures may be provided in a track grouping with metadata associating the data structures to one or more determined positions.

The apparatus may be configured so that if a listener is in a first position audio signal content sets that are not within the first subset of audio signal content sets are not retrieved and if a listener is in a second position audio signal content sets that are not within the second subset of audio signal content sets are not retrieved.

The apparatus may be configured so that the subsets of audio signal content sets cover a plurality of areas within which a listener can move and the size of the areas covered by the subsets of audio signal content sets is determined by one or more factors comprising speed of movement of the listener.

The sizes of areas covered by one or more subsets of audio signal content sets may be configured to change so that different sized areas can be covered at different times.

The audio signal content sets may comprise HOA source data wherein the HOA source data comprises one or more sets of multi-channel audio signals and one or more sets of metadata.

The plurality of positions may be provided within a listening space.

The subset of audio signal content sets that are associated with a position may comprise the audio signal content sets that enable rendering of a spatial audio scene at the position.

The subset of audio signal content sets that are associated with a position may comprise audio signal content sets that enable rendering of the spatial audio scene with a predetermined quality level.

The subset of audio signal content sets that are associated with a position may comprise audio signal content sets that enable rendering of spatial audio scenes at listener positions close to the determined position.

The apparatus may be configured so that a first subset of audio signal content sets can be associated with a position at a first time and a second different subset of audio signal content sets can be associated with the position at a second time.

The plurality of positions may be determined by dividing the listening space into a plurality of subspaces such that a subset of audio signal content sets can be associated with each subspace.

The position comprises a location and orientation in three dimensional space.

The apparatus may be configured so that a user can move through the listening space with six degrees of freedom.

The apparatus may be configured to create a manifest storing the associations between the positions and the subsets of audio signal content sets and enable the manifest to accessed by a rendering device.

The audio signal content sets may be provided in an adaptation set comprising a plurality of audio signal content sets.

The apparatus may be configured so that metadata associating the audio signal content sets with one or more positions is provided in an adaptation set.

According to various, but not necessarily all, examples of the disclosure, there may be provided a method comprising: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener if the listener is at the first position the first subset of audio signal content sets is retrieved and if the listener is at the second position the second subset of audio signal content sets is retrieved.

According to various, but not necessarily all, examples of the disclosure, there may be provided a computer program comprising computer program instructions that, when executed by processing circuitry, cause: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener if the listener is at the first position the first subset of audio signal content sets is retrieved and if the listener is at the second position the second subset of audio signal content sets is retrieved.

According to various, but not necessarily all, examples of the disclosure, there may be provided an apparatus comprising means for: obtaining information declaring available audio signal content sets that provide one or more spatial audio scenes; determining a plurality of positions in which the one or more spatial audio scenes are audible to a listener; associating a subset of audio signal content sets with the determined plurality of positions such that a first subset of audio signal content sets is associated with a first position and a second subset of audio signal content sets is associated with a second position; and retrieving audio content for rendering such that if the listener is at the first position the first subset of audio signal content sets is retrieved and if the listener is at the second position the second subset of audio signal content sets is retrieved.

According to various, but not necessarily all, examples of the disclosure, there may be provided a data structure comprising an association between HOA audio signals and HOA rendering metadata.

The HOA rendering metadata may comprise spatial metadata.

According to various, but not necessarily all, examples of the disclosure, there may be provided a track grouping comprising a plurality of data structures.

The track grouping may comprise metadata that associates the data structures within the track grouping with one or more positions within a listening space.

According to various, but not necessarily all, examples of the disclosure there is provided an apparatus comprising means for: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener the audio signal content that is retrieved is restricted to the subset of audio signal content sets that is associated with a position of the listener.

According to various, but not necessarily all, examples of the disclosure there is provided an apparatus comprising means for: obtaining information declaring available audio signal content sets that provide one or more spatial audio scenes; determining a plurality of positions in which the one or more spatial audio scenes are audible to a listener; associating a subset of audio signal content sets with the determined plurality of positions such that a first subset of audio signal content sets is associated with a first position and a second subset of audio signal content sets is associated with a second position; and retrieving audio content for rendering such that the audio signal content that is retrieved is restricted to the subset of audio signal content sets that is associated with a position of the listener.

### BRIEF DESCRIPTION

Some examples will now be described with reference to the accompanying drawings in which:

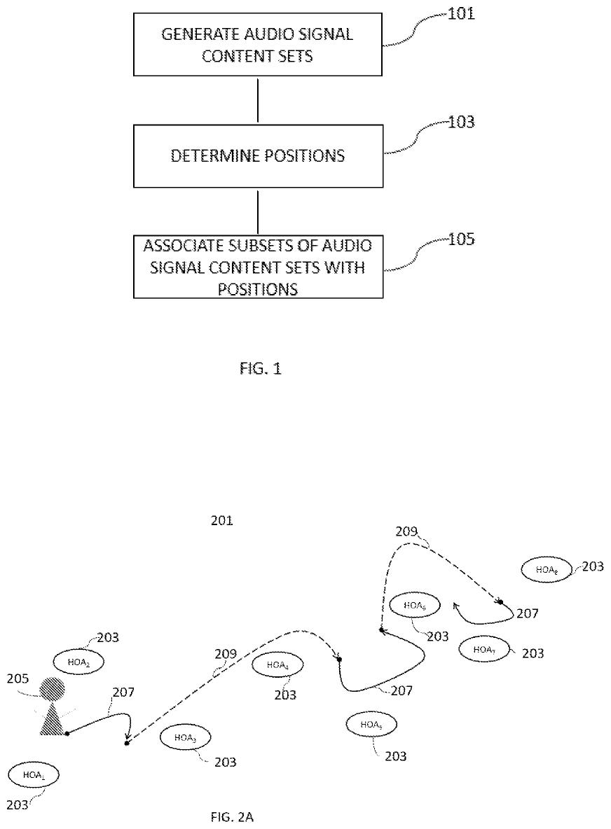

FIG. 1 shows an example method;

FIGS. 2A and 2B show an example listening space;

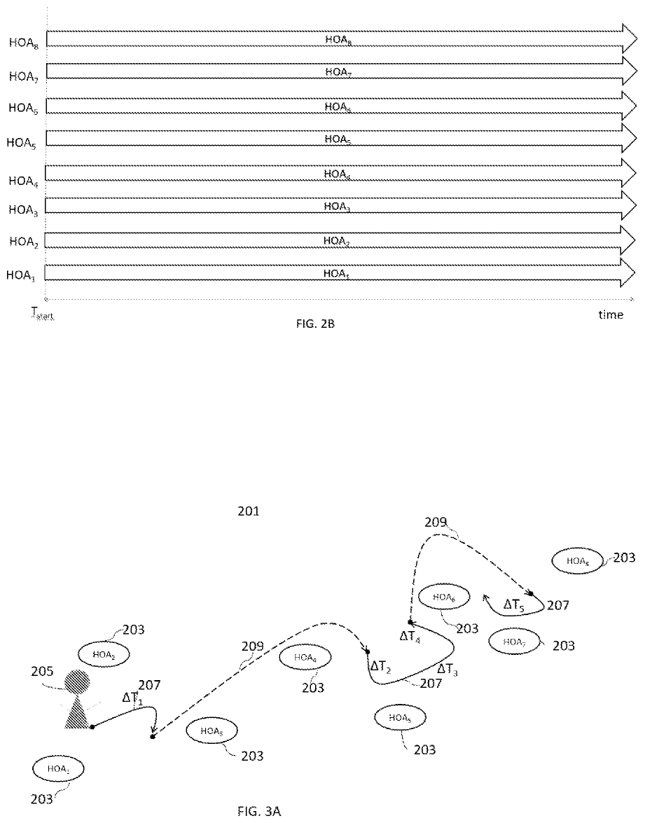

FIGS. 3A and 3B show an example listening space;

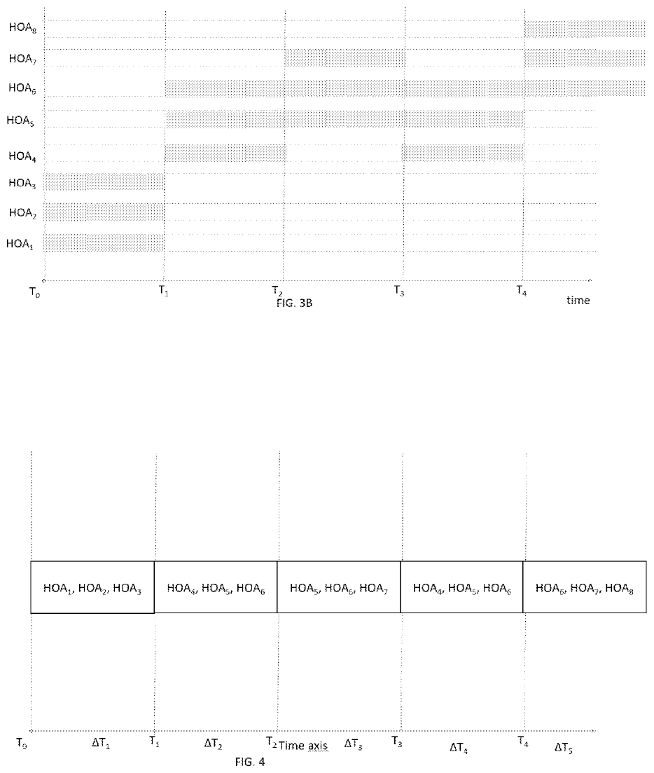

FIG. 4 shows subsets of HOA sources;

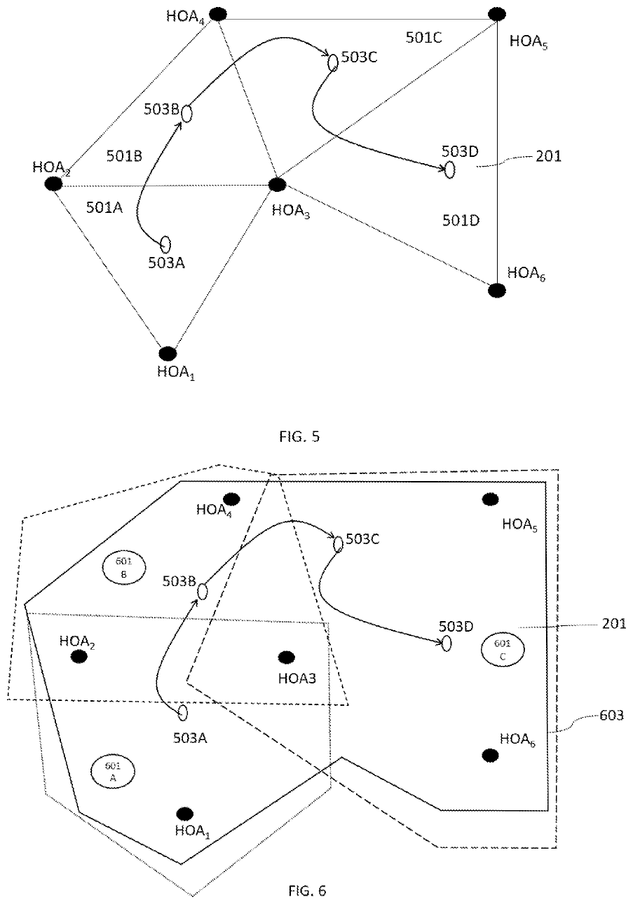

FIG. 5 shows an example listening space;

FIG. 6 shows an example listening space;

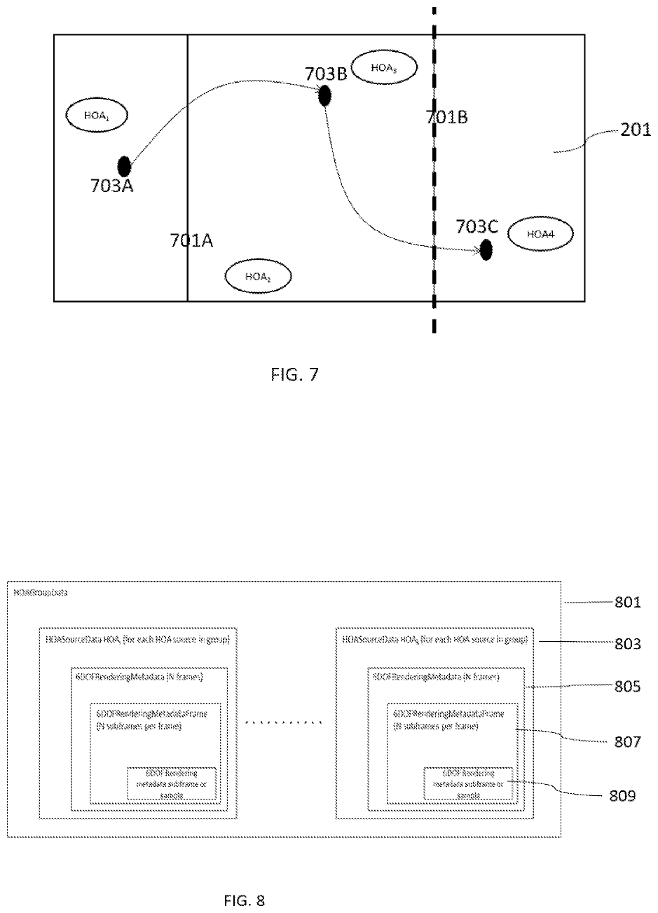

FIG. 7 shows an example listening space;

FIG. 8 shows an example data structure;

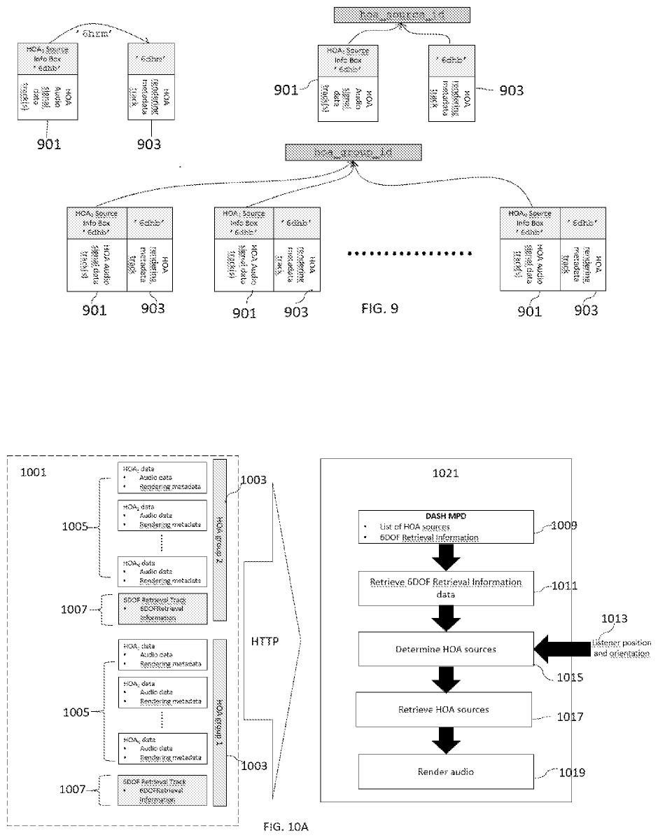

FIG. 9 shows example associations of data structures

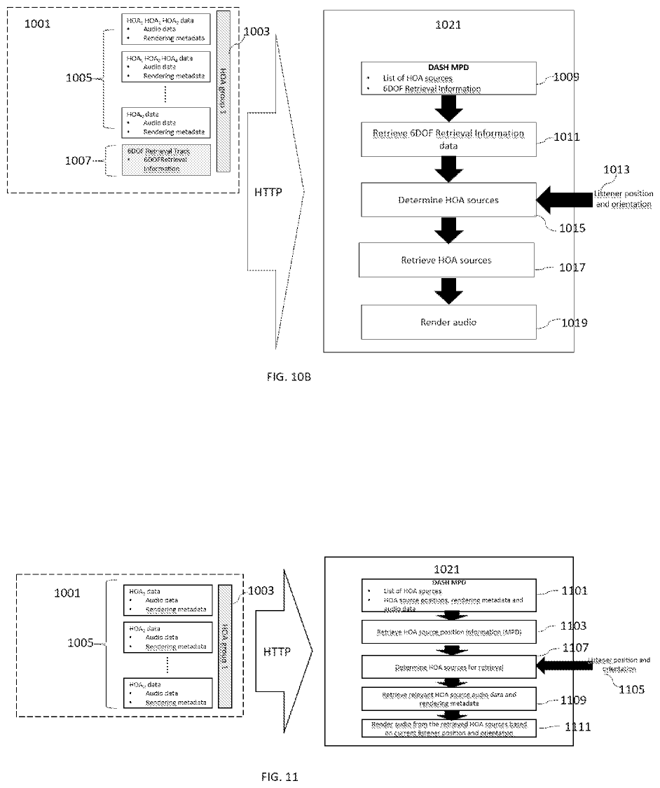

FIGS. 10A and 10B show implementations of examples of the disclosure;

FIG. 11 shows an implementation of examples of the disclosure;

FIG. 12 shows a system that can be used to implement examples of the disclosure; and

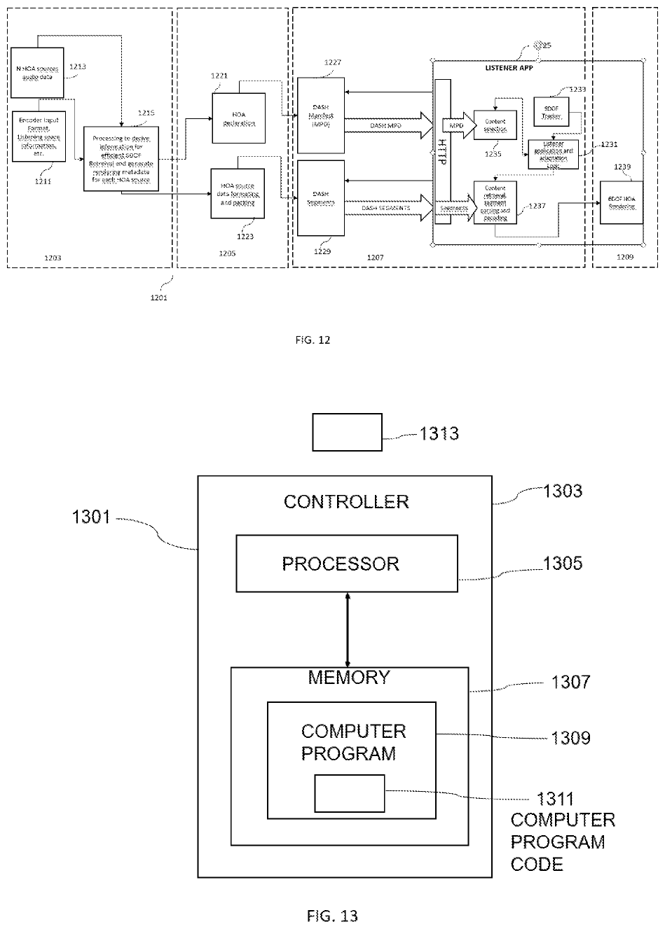

FIG. 13 shows an apparatus that can be used to implement examples of the disclosure.

### DETAILED DESCRIPTION

Examples of the disclosure relate to apparatus, systems, methods and computer programs that enable spatial audio rendering that allows for six degrees of freedom of movement of a listener. In examples of the disclosure a subset of HOA sources are identified for different positions within a listening space so when a listener is in a given position that only the subset of HOA sources that are associated with that given position need to be retrieved and processed.

FIG. 1 shows an example method that can be implemented in some examples of the disclosure.

The method shown in FIG. 1 can be implemented by an apparatus within an encoding device or any other suitable type of device.

The method comprises, at block 101, generating a plurality of audio signal content sets. The plurality of audio signal content sets provide one or more spatial audio scenes that are audible to a listener within a listening space. The audio signal content sets can comprise two or more audio channels. In such examples the device that receives the two or more audio channels can process the received audio channels to obtain spatial metadata to enable rendering of spatial audio scenes. In some other examples the audio signal content sets can comprise one or more audio channels and metadata corresponding to the one or more audio channels. In such examples the device that transmits the audio signal content, or any other suitable device, can process two or more audio signal channels to obtain the spatial metadata.

In some examples the audio signal content sets can comprise Higher Order Ambisonics (HOA) sources, or other suitable audio signal sets. The HOA sources are audio signal sets comprising HOA signals. The HOA sources can also comprise metadata relating to the HOA signals. The metadata can comprise spatial metadata that enables spatial rendering of the HOA signals. In some examples the HOA sources could comprise different types of audio signals such as stereo signals or any other type of audio signals.

The listening space can be constrained or unconstrained. In a constrained listening space the boundaries of the listening space are predefined whereas in an unconstrained listening space the boundaries are not predefined.

The listening space is a volume that represents an audio scene. A listener can be free to move within the listening space so that the listener can be in different listener positions. The listening space therefore comprises a plurality of listening positions that can be used to experience the audio scene. The listener's perception of the audio scene is dependent upon their position within the listening space. The listener's perception of the audio scene is dependent upon their position relative to sound sources within the listening space and any other factors that affect the trajectory of sound from the sound source to the position of the listener.

The listening space comprises a plurality of audio signal content sets such as HOA sources. In some examples the audio signal content sets can be positioned within the listening space. In some examples the audio signal content sets need not be positioned within the listening space but can be positioned so that the sound sources represented by the audio signal content sets sources are audible in the listening space.

The audio signal content sets can comprise sets of multi-channel audio signals or any other type of audio signals. The audio signal content sets can represent audio corresponding to sound sources that are audible within the listening space. The sound sources can be positioned within the listening space or be positioned outside of the listening space. In some examples each audio signal content set can represent one or more sound sources that is audible within the listening space.

The audio signal content sets have positions within or outside the listening space. For instance, the audio signal content sets can represent sound sources within the listening space and the sound sources can be located at specific positions within or outside the listening space.

The listening space can be configured to enable a listener to move with six degrees of freedom (6DOF) within the listening space. This can enable the listener to move with three translational degrees of freedom (forwards/backwards, left/right and up/down) and three rotational degrees of freedom (yaw, pitch and roll). To enable perception of spatial audio the audio that is provided to the listener is dependent upon the listener position.

The method comprises, at block 103, determining a plurality of positions. The plurality of positions can be within the listening space. The positions that are determined or sampled in the method can comprise both a location and an orientation within the listening space. In some examples the positions could comprise a single point within the listening space. In other examples the positions could comprise subspaces within the listening space.

Any suitable process can be used to determine the positions within the listening space. For instance in some examples a virtual listener could be positioned at a plurality of different positions within the listening space.

At block 105 the method comprises associating a subset of audio signal content sets with the determined plurality of positions such that a first subset of audio signal content sets is associated with a first position and a second subset of audio signal content sets is associated with a second position. The association is such that when audio signal content is provided for rendering to a listener the audio signal content that is retrieved is restricted to the subset of audio signal content sets that is associated with a position of the listener. That is, if a listener is in a first position the audio signal content sets that have been associated with the first position are retrieved but audio signal content sets that have not been associated with the first position are not retrieved. Similarly if the listener is in a second position the audio signal content sets that have been associated with the second position are retrieved but audio signal content sets that have not been associated with the second position are not retrieved.

The subset of audio signal content sets are associated with the determined positions so that only the subset of audio signal content sets associated with a given position are retrieved for audio rendering when a listener position corresponds to the given position. A listener position can correspond to the given position if the current listener position is within a boundary associated with the given position. The boundary can define a line, an area or a volume.

Any suitable process can be used to identify the subset of audio signal content sets that should be associated with a determined position. In some examples the process can comprise determining the minimum number of audio signal content sets that can be used to achieve a minimum audio quality level. In other examples the audio signal content sets that should be associated with a determined position could be the audio signal content sets that are closest to the determined position or the audio signal content sets that are within a predetermined distance of the determined position, or any other suitable subset of the available audio signal content sets.

The subset of audio signal content sets that are associated with a position comprise the audio signal content sets that enable rendering of a spatial audio scene at the position. Audio signal content sets that are not needed to enable rendering of the spatial audio scene at the given position are not included in the subset. For example, audio signal content sets that are positioned closer to the determined position will be necessary to enable the audio scene to accurately rendered whereas audio signal content sets that are positioned further away might not be necessary. Whether an audio signal content sets is to be associated with a position can depend on a plurality of factors such as distance between the position and the audio signal content set, orientation of the position relative to the audio signal content set, type of sound represented by the audio signal content set, volume of sound represented by the audio signal content set, objects between the position and the audio signal content set and any other suitable factors.

In some examples the subset of audio signal content sets that are associated with a position can also comprise audio signal content sets that enable rendering of spatial audio scenes at listener positions close to the determined position. This provides a buffer region that can enable movement of the listener to be taken into account. In such examples the audio signal content sets needed to render spatial audio scenes at the determined position and also the audio signal content sets needed to render the spatial audio scenes within a predetermined distance around the determined position are associated with the position.

The subset of audio signal content sets associated with a determined position can be dynamic so that it can change over time. For example the sound scene may change due to one or more of the sound sources within a listening space moving or due to different sound sources being active. In some embodiments, this may affect how the subsets are determined. In such examples a first subset of audio signal content sets can be associated with a determined position at a first time and a second different subset of audio signal content sets can be associated with the determined position at a second time.

When a subset of audio signal content sets is associated with a position information indication the subset of audio signal content sets for each s determined position is stored. This information can be made available to rendering devices to enable the necessary subset of audio signal content sets to be retrieved during spatial audio rendering.

In some examples the associations between the positions and the subsets of audio signal content sets can be stored in one or more manifests. The manifests comprise lists of the determined positions and the subsets of audio signal content sets that are associated with each subset of the positions. The manifests can be accessed by a rendering device to enable rendering of the audio signals.

The information indicating the subset of audio signal content sets that are associated with the positions within the listening space can be made available to the rendering devices in any suitable way. In some examples information indicating the subset of audio signal content sets associated with the plurality of determined positions can be provided as a timed metadata track.

In some examples the subsets of audio signal content sets cover a plurality of areas within which a listener can move. The sizes of the areas can be selected so as to avoid glitches in rendered audio as a listener moves within a listening space. The sizes of the areas covered by the subsets of audio signal content sets can be determined by one or more factors comprising speed of movement of the listener. In such examples a plurality of different possible speeds or speed ranges of a listener can be identified. In such examples additional information such as retrieval delay estimates based on network bandwidth and latency or any other suitable information that could be used to reduce glitches can also be obtained. The different sizes of areas can be labelled or otherwise identified according to the corresponding speed of movement, expected network bitrate and latency so that the appropriately sized area can be used when retrieving the subsets of audio signal content. For instance, if a listener is moving quickly within the listening space the subsets of audio signal content sets can be configured to cover a larger area than if the listener is moving slowly so as to reduce delays in obtaining audio signal content for new listener positions. This can enable different subsets of audio signal content sets to be associated with a given position in different circumstances. The audio signal content sets that are within a given subset will be dependent upon the speed of the listener and/or any other suitable factors.

The method of FIG. 1 can be performed by any suitable device. In some examples the associating of the subset of audio signal content sets with the determined plurality of positions within the listening space is performed by a device that captures the audio signal content sets. In some examples the method could be performed by an intermediate devices such as a server or one or more cloud based devices.

In other examples the associating of the subset of audio signal content sets with the determined plurality of positions within the listening space can be performed by a device that receives the audio signal content sets for rendering. In such examples a rendering device can obtain information declaring available audio signal content sets that provide one or more spatial audio scenes. This obtained information can then be used to determine a plurality of positions in which the one or more spatial audio scenes are audible to a listener and associate a subset of audio signal content sets with the determined plurality of positions such that a first subset of audio signal content sets is associated with a first position and a second subset of audio signal content sets is associated with a second position. When the audio content is retrieved for rendering the audio signal content that is retrieved is restricted to the subset of audio signal content sets that is associated with a position of the listener.

FIGS. 2A and 2B shows an example listening space 201 and the audio signal content sets that are provided within the listening space 201 in a system that does not implement examples of the disclosure. In this example the audio signal content sets comprise HOA sources 203.

FIG. 2A shows the listening space 201. The listening space 201 comprises eight HOA sources 203. It is to be appreciated that other numbers of HOA sources 203 could be used in other examples of the disclosure. Each of the HOA sources 203 can represent one or more sound sources within the listening space 201. Each of the HOA sources 203 has a position and orientation within the listening space 201.

The listening space 201 could represent a virtual reality environment. For example, it could be a gaming environment or any other suitable type of environment.

A listener 205 is positioned within the listening space 201. The listener 205 can move freely within the listening space 201. The listener can move 205 with six degrees of freedom within the listening space 201.

The arrows 207, 209 show an example trajectory for the listener 205 through the listening space 201. The solid arrows 207 represent the listener 205 moving slowly through the listening space 201. For example, the listener 205 could be walking through a virtual reality environment. The dashed arrows 209 represent the listener 205 moving quickly through the listening space 201. For example, the listener 205 could be teleported through a virtual reality environment. When the listener 205 moves quickly through the listening space 201 this causes sudden and significant changes in a short temporal duration in the audio scene corresponding to the current listener position.

FIG. 2B shows the sets of audio signals 203 that are delivered to a rendering device when a listener is following the trajectory as shown in FIG. 2A. In the example shown in FIG. 2B all of the HOA sources 203 within the listening space 201 are delivered to the rendering device for all of the time that the listener 205 is within the listening space 201. This requires a large amount of bandwidth to enable all of the data to be transmitted to the rendering device and is computationally intensive for the rendering device to process.

FIGS. 3A and 3B show an example listening space 201 and the audio signal content sets that are needed to enable rendering of the listening space 201 in a system that does implement an example of the disclosure. In this example the audio signal content sets comprise HOA sources.

FIG. 3A shows the listening space 201. The listening space 201 comprises a plurality of HOA sources 203 as shown in FIG. 2A. Corresponding reference numerals are used for corresponding features.

The arrows 207, 209 show an example trajectory for the listener 205 through the listening space 201. FIG. 3B shows the subsets of audio signals sets 203 that are delivered to a rendering device when a listener is following the trajectory as shown in FIG. 3A. In this example the subsets of HOA sources 203 that are delivered to the rendering device are dependent upon the listener position. Only the subsets of the HOA sources 203 that are associated with the position of the listener are delivered to the rendering device. The HOA sources 203 that are associated with the positions can be determined using a method such as the method of FIG. 1.

In time period T₁ the listener 205 is walking between a first position and a second position. In this time period the listener 205 is positioned close to the first HOA source HOA₁, the second HOA source HOA₂ and the third audio signal HOA₃ set but is positioned far away from the other HOA sources. The audio scenes corresponding to this listener position can therefore be rendered using the first, second and third HOA sources HOA₁, HOA₂ and HOA₃. In examples of the disclosure the first, second and third HOA sources HOA₁, HOA₂ and HOA₃ are associated with these positions so that for the time period T₁ only the first, second and third HOA sources HOA₁, HOA₂ and HOA₃ are delivered to the rendering device.

In time period T₂ the listener 205 has teleported to a position close to the fourth HOA source HOA₄. In this position the first, second and third HOA sources HOA₁, HOA₂ and HOA₃ are no longer needed because the listener 205 has moved further away from them. However, in this new position the fourth, fifth and sixth HOA sources HOA₄, HOA₅ and HOA₆ are needed. Therefore, in time period T₂ the subset of HOA sources 203 that is delivered to the rendering device comprises the fourth, fifth and sixth HOA sources HOA₄, HOA₅ and HOA₆ but not the first, second or third HOA sources HOA₁, HOA₂ and HOA₃.

In time period T₃ the listener 205 walks towards a position close to the sixth HOA source HOA₆. In this position the listener 205 moves further away from the fourth HOA source HOA₆ but moves closer to the seventh HOA source HOA₇. Therefore, in time period T₃ the subset of HOA sources 203 that is delivered to the rendering device comprises the fifth, sixth and seventh HOA sources HOA₅, HOA₆ and HOA₇ but not the first, second, third or fourth HOA sources HOA₁, HOA₂, HOA₃ and HOA₄ all of which had been delivered previously.

In time period T₄ the listener 205 walks back towards a position closer to the fourth HOA source HOA₄ and further away from the seventh HOA source HOA₇. Therefore, in time period T₄ the subset of HOA sources 203 that is delivered to the rendering device comprises the fourth, fifth and sixth HOA sources HOA₄, HOA₅ and HOA₆ but not the first, second, third or seventh HOA sources HOA₁, HOA₂, HOA₃ and HOA₇.

In time period T₅ the listener 205 has teleported to a position close to the eighth HOA source HOA₈. In this position the sixth, seventh and eighth HOA sources HOA₆, HOA₇ and HOA₈ are needed to render the audio scenes corresponding to the listener position. Therefore, in time period T₅ the subset of HOA sources 203 that is delivered to the rendering device comprises the sixth, seventh and eighth HOA sources HOA₆, HOA₇ and HOA₈ but not any of the other HOA sources 203 that have previously been delivered.

This therefore means that only the subsets of audio signals 203 that are needed to render the audio position for the current listener position are delivered to the rendering device. This provides for a reduction in the bandwidth used compared to the system used in FIGS. 2A and 2B and reduces the computational requirements for the rendering device.

FIG. 4 shows subsets of HOA sources 203 corresponding to the examples shown in FIGS. 3A and 3B. In this example the subsets of HOA sources 203 needed to render the audio scenes for each of the determined listener positions within the listening space 201 are identified. The HOA sources within a subset are grouped together and associated with the determined listener positions. When the listener 205 is determined to be at a given position the subset associated with that position can then be retrieved as a single group. Therefore, in the example shown in FIG. 4 the rendering device can retrieve a subset of the HOA sources 203 for each of the different time periods. The subsets comprise one or more of the HOA sources 203 grouped into a single subset.

FIG. 5 shows another example listening space 201 to schematically illustrate another example implementation of the disclosure. In this example the listening space 201 comprises six HOA sources HOA₁ to HOA₆. The HOA sources HOA₁ to HOA₆ are distributed within the listening space 201.

In the example shown in FIG. 5 the positions within the listening space 201 have been determined and a subset of the HOA sources HOA₁ to HOA₆ have been associated with each position. In the particular example of FIG. 5 the listening space 201 has been divided into a plurality of subspaces 501. In this example the subspaces have been created by dividing the listening space 201 into a plurality of triangular areas with one of the HOA sources HOA₁ to HOA₆ positioned on each of the corners of the triangle. The HOA sources at each corner of the triangle provide the subset of HOA sources that are associated with each subspace 501. Therefore the subset of HOA sources HOA₁ to HOA₆ that are associated with a position can be determined by determining which subspace the position is within.

The example shown in FIG. 5 comprises a four triangular subspaces 501A, 501B, 501C and 501D. The subspaces 501A, 501B, 501C and 501D encompass all of the listening space 201 so that each position within the listening space 201 falls within at least one of the subspaces 501A, 501B, 501C and 501D.

The first subspace 501A has the first HOA source HOA₁ on a first corner, the second audio signal HOA₂ set on a second corner and the third audio signal HOA₃ set on a third corner. The subset of HOA sources that is associated with the first subspace 501A therefore comprises the first, second and third HOA sources HOA₁, HOA₂ and HOA₃.

The second subspace 501B has the second HOA source HOA₂ on a first corner, the third HOA source HOA₃ on a second corner and the fourth HOA source HOA₄ on a third corner. The subset of HOA sources that is associated with the second subspace 501B therefore comprises the second, third and fourth HOA sources HOA₂, HOA₃ and HOA₄.

The third subspace 501C has the fourth HOA source HOA₄ on a first corner, the third HOA source HOA₃ on a second corner and the fifth HOA source HOA₅ on a third corner. The subset of HOA sources that is associated with the third subspace 501C therefore comprises the third, fourth and fifth HOA sources HOA₃, HOA₄ and HOA₅.

The fourth subspace 501D has the fifth HOA source HOA₅ on a first corner, the third audio signal HOA₃ set on a second corner and the sixth HOA source HOA₆ on a third corner. The subset of HOA sources that is associated with the fourth subspace 501D therefore comprises the third, fifth and sixth HOA sources HOA₃, HOA₅ and HOA₆.

When the audio scene is being rendered the subset of HOA sources HOA₁ to HOA₆ that are retrieved by the rendering device is dependent upon the position of the listener 205. The rendering device only needs to retrieve the subset of HOA sources HOA₁ to HOA₆ that are associated with the subspace 501 in which the listener is positioned.

When a listener is positioned at the first position 503A this is determined to be within the first subspace 501A and so the rendering device only needs to retrieve the first, second and third HOA sources first, second and third HOA sources HOA₁, HOA₂ and HOA₃. Similarly the second listener position 503B shown in FIG. 5 is located in the second subspace 501B. When the listener 205 is located in this position the rendering device only needs to retrieve the second, third and fourth HOA sources HOA₂, HOA₃ and HOA₄. The third listener position 503C is located in the third subspace 501C. When the listener 205 is located in this position the rendering device only needs to retrieve the third, fourth and fifth HOA sources HOA₃, HOA₄ and HOA₅. The fourth listener position 503D is located in the fourth subspace 501D. When the listener 205 is located in this position the rendering device only needs to retrieve the third, fifth and sixth HOA sources HOA₃, HOA₅ and HOA₆.

In the example shown in FIG. 5 the subspaces 501 are two dimensional and cover an area of the available listening space 201. It is to be appreciated that the listening space 201 can be a three dimensional space and that the subspaces could comprise three dimensional volumes.

It is also to be appreciated that other shapes could be used for the subspaces 501 in other examples of the disclosure. The shape of the subspaces 501 that are used can depend on the methods that are used to associate the subset of HOA sources with the determined positions.

Also in the example of FIG. 5 each subspace has three HOA sources associated with it. Other numbers of HOA sources could be associated with each of the subspaces in other examples of the disclosure. In some examples different subspaces could provide different audio quality levels. The different audio quality levels could be obtained by associating different numbers of HOA sources with the different subspaces.

FIG. 6 shows another example listening space 201 that has been divided into a plurality of subspaces 601A, 601B, 601C. The listening space 201 comprises six HOA sources HOA₁ to HOA₆. The HOA sources HOA₁ to HOA₆ are distributed within the listening space 201 in a manner similar to that shown in FIG. 5. However, in the example shown in FIG. 6 a boundary 603 is provided around the edge of the listening space 201. The boundary 603 could represent solid walls within a real audio space or any other suitable boundaries.

In the example shown in FIG. 6 a different method is used to divide the listening space 201 into subspaces 601 compared to the method used in FIG. 5. In this example the subspaces 601 can be overlapping so that a listener position could fall within two or more subspaces.

In the example of FIG. 6 each of the subspaces 601 comprises three HOA sources. In other examples the subspaces 601 could be configured to comprise a different number of HOA sources.

The first subspace 601A comprises the first, second and third HOA sources HOA₁, HOA₂ and HOA₃. The second subspace 601B partially overlaps with the first subspace 601A. The second subspace comprises the second, third and fourth HOA sources HOA₂, HOA₃ and HOA₄. The third subspace 601C partially overlaps with both the first subspace 601A and the second subspace 601B and comprises the third, fifth and sixth HOA sources HOA₃, HOA₅ and HOA₆.

The subsets of HOA sources that are retrieved for rendering are dependent upon the subspace 601 in which the listener 205 is positioned. If a listener 205 is determined to be in a position in which two or more subspaces 601 overlap then the subset of audio signals associated with each of the subspaces 601 can be retrieved.

FIG. 7 shows another example listening space 201 that has been divided into a plurality of overlapping subspaces 701A, 701B. The listening space 201 comprises four HOA sources HOA₁ to HOA₄. The HOA sources HOA₁ to HOA₄ are distributed within the listening space 201.

In the example of FIG. 7 each of the subspaces 701A, 701B comprises three HOA sources. In other examples the subspaces 701 could be configured to comprise a different number of HOA sources.

The first subspace 701A comprises the first, second and third HOA sources HOA₁, HOA₂ and HOA₃. The second subspace 701B partially overlaps with the first subspace 701A. The second subspace comprises the second, third and fourth HOA sources HOA₂, HOA₃ and HOA₄.

As a listener 205 traverses through the listening space 201 different subsets of the HOA sources HOA₁ to HOA₄ are retrieved by the rendering device. For example, if the listener 205 starts in the first position 703A this is located within the first subspace 703A. Only the first, second and third HOA sources HOA₁, HOA₂ and HOA₃ need to be retrieved for audio rendering when the listener 205 is at this first position 703A.

The listener 205 then moves from the first position 703A to the second position 703B. the second position 703B is in the location where the first subspace 701A and the second subspace 701B overlap. The HOA sources that are associated with each of the overlapping subspaces 701A, 701B are retrieved when the listener 205 is in this position. In this example when the listener 205 is in the second position 703B all of the HOA sources HOA₁ to HOA₄ are retrieved. As the first three HOA sources HOA₁ to HOA₃ were already retrieved when the listener 205 was in the first position 703A only the additional fourth HOA source HOA₄ needs to be retrieved when the listener 205 moves to the second position 703B.

The listener 205 can then move from the second position 703B to the third position 703C. The third position 703C is located within the second subspace 701B. Only the second, third and fourth HOA sources HOA₂, HOA₃ and HOA₄ need to be retrieved for audio rendering when the listener 205 is at this third position 703C. This means that the first HOA source HOA₁ is no longer needed when the listener 205 is in the third position.

It is to be appreciated that other variations of the subspaces could be made in other examples of the disclosure. For instance, in some examples the subspaces could have guard ranges that could provide an indication of the range that the listener 205 can travel while maintaining the required audio quality with the subset of HOA sources that are associated with the subspace.

The process of creating the content for the HOA sources is followed by the process of declaring the content for the HOA sources. The process for declaring the content for the HOA sources has to enable efficient delivery of the HOA sources and also simple retrieval of the HOA sources.

FIG. 8 shows an example high-level structure that can be used to store the bitstream for HOAs or other types of audio signal sets.

The bitstream comprises HOA group data 801. This comprises data indicating all of the HOAs within a group. The HOA group data can comprise the subset of HOAs that are associated with a position or subspace within a listening space 201.

The HOA group data 801 comprises the HOA source data 803 for each HOA source within the group. The HOA source data 803 comprises the 6DOF rendering metadata 805. The 6DOF rendering metadata comprises spatial metadata which provides parameters such as the direction of arrival of the propagating sound. The spatial metadata can comprise information that enables the spatial aspects of the HOA sources to be recreated by rendering devices.

The 6DOF rendering metadata 805 comprises a plurality of frames 807. Each of the frames 807 of the 6DOF rendering metadata 805 comprises a plurality of subframes or samples 809. In other examples there need not be any subframes within the frames 807 so that each frame 807 provides an indivisible unit.

The high level structure shown in FIG. 8 can be described using the syntax below. In this syntax it is to be appreciated that the exact sub_frame duration, audio_frame_duration and number of frequency bands can evolve. In this example syntax it is assumed that the HOA sources are static and that the HOA rendering metadata is at sub_frame which is an integer multiple of the audio_frame. In this syntax random access is possible for every sub_frame interval. It is possible that the audio data arrives separate from the rendering metadata.

```
aligned (8) 6DoFBitStream ( ) {
  SceneEIFStruct ( ) ; //re-use scene.xml
  unsigned int (32) audio_frame_duration; //512 for 48KHz
  unsigned int (32) subframes_duration; //128 samples at48KHz
  unsigned int (32) sampling_rate;// e.g., 48KHz not used
right now
  unsigned int (8) num_hoa_groups;
  for (i=0; i<num_hoa_groups; i++) {
    HOAGroupData ( ) ;
  }
}
aligned (8) HOAGroupData ( ) {
  unsigned int (16) hoa_source_group_id; //Unique HOA group
identifier
  unsigned int (8) num_hoa_sources_in_group; //HOA source per
each group
  for (i=0; i< num_hoa_sources_in_group; i++) {
  HOASourceData ( ) ;
  }
}
aligned (8) HOASourceData ( ) {//Data for each HOA source except
the audio waveforms
  HOASourceInformationStruct ( ); //HOA source information
  unsigned int (3) hoa_order; //order of HOA source
  HOA6DOFRenderingMetadata ( ) ;//HOA source rendering
metadata per channel
}
aligned (8) HOASourceInformationStruct ( ) {
  HOASourcePositionStruct ( ) ;//position of the HOA source
  unsigned int (16) hoa_source_id;//unique identifier for
each HOA source
  bit (5) reserved = 0;
}
aligned (8) HOASourcePositionStruct ( ) {
  signed int (32) hoa_source_pos_x;
  signed int (32) hoa_source_pos_y;
  signed int (32) hoa_source_pos_z;
  signed int (16) hoa_source_rot_yaw;
  signed int (16) hoa_source_rot_pitch;
  signed int (16) hoa_source_rot_roll;
}
```

Semantics: The hoa_source_pos_x, hoa_source_pos_x, hoa_source_pos_x is the position of each HOA source in units of 10⁻¹ millimeters relative to the global coordinate system. The hoa_source_rot_yaw, hoa_source_rot_roll and hoa_source_rot_pitch is the HOA source orientation. The yaw and roll is defined in units of 2⁻¹⁶ degrees with range of −180 to 180-step_size [−180*2¹⁶ to 180*2¹⁶−1, inclusive] and pitch is defined with units of 2⁻¹⁶ degrees with range of −90 to 90-step_size [−90*2¹⁶ to 90*2¹⁶−1, inclusive].

```
aligned (8) HOA6DOFRenderingMetadata ( ){//metadata describing
the prototype signal
  unsigned int(64) num_frames; //this represents the entire
track or duration
  for (i=0; i<num_frames;i++) {
    HOA6DOFRenderingMetadataFrame ( );
  }
}
aligned (*) HOA6DOFRendermetadataFrame ( ) {//A single frame
with N samples
  unsigned int(32) subframes_per_frame;// current value is
4
  for (i=0; i<subframes_per_frame;i++) {
    HOA6DOFRenderingMetadataInformationSample ( ) ;
  }
}
aligned(8) HOA6DOFRenderingMetadataImformationSample ( ) {
  unsigned in(8) num_frequency_bands; //Current number is
133.
  for (i=0; i<num_frequency_bands;i++) {
    signed int(16) hoa_render_meta_azimuth;
    signed int(16) hoa_render_meta_elevation;
    unsigned int(16) direct_to_total_energy_ration; //
float as int16
unsigned int(32) overall_energy; // float as int32
  }
}
```

The hoa_render_meta_azimuth and hoa_render_meta_elevation is defined in units of 2⁻¹⁶ degrees with range of −180 to 180-step_size [−180*2¹⁶ to 180*2¹⁶−1, inclusive].

```
aligned (8) HOAGroupInformationStruct ( ) {
  unsigned int (16) hoa_source_group_id; //Unique HOA group
identifier
  unsigned int (1) hoa_retrieval_delay_adaptation;
  bit (7) reserved = 0;
}
```

In this structure the hoa_source_id is the unique identifier for each HOA source within a listening space.

In this structure if hoa_retrieval_delay_adaptation is equal to 0, the rendering device should render content only using the HOA sources specified by the content creator. If hoa_retrieval_delay_adaptation is equal to 1, the client is free to perform adaptation of the rendering with the HOA sources as deemed suitable by the rendering device. For instance, this value can indicate whether or not the rendering should be adapted or whether or not rendering should be stopped. This could be used in cases where not all HOA sources are received, for instance if the transmission fails for one or more of the HOA sources.

In examples of the disclosure the subset of the available HOA sources that are to be used for a given listener position or subspace can be indicated in a new box. FIG. 9 shows examples of the new box and how this can be grouped into information relating to a subset of HOAs. As this information enables six degrees of freedom of movement of the listener 205 this box is referred to as 6DOFHOABox(‘6dhb’). This box can be contained in the sample entry of the audio signal data tracks and the associated HOA rendering timed metadata tracks.

```
aligned (8) 6DOFHOABox ( ) extends FullBox ( ′ 6dhb ′ , 0, flags) {
#container: AudioSampleEntry or Timed metadata. New
definition
  HOASourceInformationStruct ( ) ;
  unsigned int (1) hoa_source_audio_or_render_meta;
  bit (7) reserved = 0;
}
```

The value of hoa_source_audio_or_render_meta shall be equal to 1 if it is an audio data struct and 0 if it is in the rendering metadata struct.

The HOA rendering metadata can be represented as a timed metadata track which comprises header information that connects it to the HOA audio signal data tracks. The HOA rendering metadata can comprise spatial metadata which provides parameters such as the direction of arrival of the propagating sound. The spatial metadata can comprise information that enables the spatial aspects of the HOA sources to be recreated by the rendering devices.

As an example, the spatial metadata can contain a direction value (azimuth and elevation) and a direct-to-total energy ratio value. The azimuth can be presented using int(16), the elevation using int(8), and the direct-to-total energy ratio using int(16). A given number of frequency bands are used. In some examples 32 frequency bands could be used. The 32 frequency bands could follow the Bark bands or any other suitable frequency resolution. The frame size for the spatial metadata could be 10 ms or any other suitable frame size.

The example information format for the rendering metadata given above can provide a sample entry for a timed metadata track for the HOA rendering metadata. Each sample entry of the timed metadata track that contains the HOA rendering metadata is associated with the HOA source audio tracks by a new track reference ‘6hrm’ as shown in FIG. 9. A new sample entry is defined ‘6dhm’ for the 6DOF HOA rendering metadata associated with each HOA source.

A sample syntax can be defined for the timed metadata track as follows:

class HOA6DoFSampleEntry extends MetaDataSampleEntry ( ′ 6dhm′ ) {
HOA6DoFRenderingMetadataInformationStruct ( ) ;
}

The sample syntax can be defined as follows:

class HOA6DoFSample ( ) {
HOA6DoFRenderingMetadataInformationStruct ( ) ;
{

In the above example values, the rendering metadata is obtained for each HOA source every 10 milliseconds. Inside the frame, the metadata can be structured so that first the azimuth value for each frequency band is stored, then the elevation value for each frequency band, and finally the direct-to-total energy ratio for each frequency band, resulting in the example stream:

azi[0], azi[1], azi[2], . . . , azi[31], ele[0], ele[1], ele[2], . . . , ele[31], ratio[0], ratio[1], ratio[2], . . . , ratio[31].

In some examples the spatial metadata can be encoded so as to decrease the amount of data needed to be transmitted. Any suitable methods for direction and direct-to-total energy ratio compression can be used to decrease the amount of data transmitted.

In other examples all of the timed metadata tracks belonging to the same HOA source have the same value of track_group_id for track_group_type ‘6dho’. Thus track_group_id can be used to identify the metadata tracks associated with a HOA source in addition to the hoa_source_id.

FIG. 9 shows subsets of HOA sources and how the source data for these sets can be combined with a metadata track for transmission to a rendering device.

As shown in FIG. 9 a new track reference 6hrm is used to associate each sample entry of the timed metadata track that contains the HOA rendering metadata 903 with the HOA source audio tracks 901.

The grouped HOA rendering metadata 903 and HOA source audio tracks 901 are grouped together with the hoa_source_id. This signals the relationship between the HOA rendering metadata 903 and the HOA source audio tracks 901.

The subset of HOA sources that are associated with a position in a listening space 201 are then grouped together as shown in FIG. 9. In FIG. 9 the subset comprises three HOA sources however it is to be appreciated that other numbers of sources could be used in other examples of the disclosure. The subset of HOA sources are grouped together with the hoa_group_id. This provides a common group identifier that signals all of the HOA sources that are associated with a given position or subspace within the listening space 201.

FIG. 9 therefore shows HOA source subset bundles which contain HOA source audio data and rendering metadata in a single transport segment. Each of these bundles could provide an adaptation set. This facilitates the synchronization process for the rendering device and can simplify the processes that need to be performed by the rendering device in order to enable the spatial audio rendering.

The bundles as shown in FIG. 9 provide a data structure comprising an association between HOA audio signals and HOA rendering metadata. The HOA rendering metadata comprises spatial metadata.

A plurality of data structures are then provided in a track grouping than can also comprise metadata that associates the data structures within the track grouping with one or more positions within a listening space 201.

The determined positions within the listening space 201 can be indexed using any suitable method. In some examples the different subspaces within the listening space can be defined based on the HOA sources that are requires to render the audio scene at a predefined quality level. That is, the different subspaces can be defined by the HOA sources that are associated with the subspace. This can be implemented using a structure as follows:

```
aligned (8) 6DOFSubspaceStruct ( ) {
  unsigned int (32) subspace_id;
  signed int (32) subspace_pos_x;
  signed int (32) subspace_pos_y;
  signed int (32) subspace_pos_z;
  signed int (32) subspace_rot_yaw;
  signed int (32) subspace_rot_pitch;
  signed int (32) subspace_rot_roll;
  signed int (32) subspace_size_x;
  signed int (32) subspace_size_y;
  signed int (32) subspace_size_z;
}
```

The structure given above provides a cubic listening space 201. It is to be appreciated that other geometrical shapes or meshes with a suitable number of faces can be used for the listening space 201 in other examples of the disclosure.

The listening space 201 can be divided into subspaces as shown in the examples of FIGS. 5 to 7. Any suitable criteria can be used to divide the listening space 201 into a plurality of subspaces. In some examples the listening space 201 can be divided into the minimum number of subspaces. In such examples larger subspaces are provided while restricting the maximum number of HOA sources that need to be retrieved. In other examples the listening space 201 can be divided into subspaces so that each subspace comprises a minimum number of HOA sources. This example increases the number of subspaces that are needed but can reduce the content that needs to be delivered for a given listener position.

The subspaces can be any suitable shape within the listening space 201. The subspaces could be cubes, triangles or any other geometrical shapes or meshes with a suitable number of faces. In other examples the subspaces can be defined as two dimensional areas with a predefined permitted elevation within the area.

The retrieval information for each subspace within the listening space can be described with the following data structure:

```
aligned (8) 6DOFSubspaceRetrievalStruct ( ) {
  unsigned int (32) subspace_id;
  6DOFSubspaceStruct ( ) ;
  unsigned int (8) numHOASources;
  for (m = 0; m < numHOASources; m++) {
    unsigned int (8) hoa_source_id [m] ;
  }
}
```

The retrieval information for the entire listening space 201 for a particular temporal segments can be described with the following data structure:

```
aligned (8) 6DOFRetrievalStruct ( ) {
  unsigned int (32) num_subspaces;
  for (m = 0; m < numSubpaces; m++) {
    6DOFSubspaceRetrievalStruct ( ) ;
  }
}
```

In some examples the subspace retrieval information in 6DOFRetrievalStruct( ) can be delivered as an MHAS packet with packet type PACTYP_MPEGH6DOFSUBRET. This packet can be used by the rendering device to determine the HOA sources that are requires for rendering. The rendering device can be expected to pre-fetch 6DOFRetrievalStruct( ) for an upcoming timeline in order to retrieval of the required HOA sources data and rendering metadata.

In some examples the HOA source information can be declared in an MPD (Media Presentation Description) for a DASH (Dynamic Adaptive Streaming over HTTP) based delivery mechanism as shown in the table below. In this table M refers to mandatory, CM refers to conditionally mandatory and O refers to optional.

| Elements and | | | |
|---|---|---|---|
| attributes for | | | |
| HOA source | | Data | |
| descriptor | Use | type | Description |
| @value | M | xs:string | Specifies the hoa_source_id of |
| | | | the HOA source in the listening |
| | | | space. The value is a string that |
| | | | contains a base-10 integer |
| | | | representation of a HOA source |
| | | | ID. |
| | | | In case of multiple or “N” HOA |
| | | | source IDs packed in a single |
| | | | frame, this can be a whitespace- |
| | | | separated list of HOA source IDs |
| | | | as indicated by hoa_source_id. |
| HOA_Source_Position.HOA_Source_Position_X | 1 . . . N | xs:string | X coordinate Position of HOA |
| | | | source, or a whitespace- |
| | | | separated list of X position of the |
| | | | HOA sources listed in the @value. |
| | | | The number of position values |
| | | | shall be equal to the number of |
| | | | hoa_source_id listed in @value |
| | | | field. |
| | | | This information is 1 if there is only |
| | | | one HOA source in one |
| | | | adaptation set, N if there are N |
| | | | HOA sources packaged in the |
| | | | same DASH segment. |
| HOA_Source_Position.HOA_Source_Position_Y | 1 . . . N | xs:string | Y coordinate Position of HOA |
| | | | source, or a whitespace- |
| | | | separated list of Y position of the |
| | | | HOA sources listed in the @value. |
| | | | The number of position values |
| | | | shall be equal to the number of |
| | | | hoa_source_id listed in @value |
| | | | field. |
| | | | This information is 1 if there is only |
| | | | one HOA source in one |
| | | | adaptation set, N if there are N |
| | | | HOA sources packaged in the |
| | | | same DASH segment. |
| HOA_Source_Position.HOA_Source_Position_Z | 1 . . . N | xs:string | Z coordinate Position of HOA |
| | | | source, or a whitespace- |
| | | | separated list of Z position of the |
| | | | HOA sources listed in the @value. |
| | | | The number of position values |
| | | | shall be equal to the number of |
| | | | hoa_source_id listed in @value |
| | | | field. |
| | | | This information is 1 if there is only |
| | | | one HOA source in one |
| | | | adaptation set, N if there are N |
| | | | HOA sources packaged in the |
| | | | same DASH segment. |
| HOA_Source_AudioData_or_RenderingMetadata_Flag | O | int | This indicates if a given |
| | | | adaptation set represents HOA |
| | | | source spatial metadata or audio |
| | | | data or a composite adaptation |
| | | | set comprising both. Absence of |
| | | | this flag will be considered to |
| | | | indicate a composite adaptation |
| | | | set. |
| HOA_Source_Order.Order | CM | int | Order of the HOA source. All the |
| | | | HOA source orders in case of |
| | | | more than one HOA sources in a |
| | | | single adaptation set will be the |
| | | | same order. This information is |
| | | | optional. |
| | | | This information is conditionally |
| | | | mandatory if there are more than |
| | | | one adaptation sets of a single |
| | | | HOA source. In this case each |
| | | | HOA source with different order |
| | | | needs to be labelled. |
| HOA_Source_Group_Info.groupId | CM | int | This attribute specifies the |
| | | | identifier of the HOA source group |
| | | | that this HOA source belongs to. |
| | | | This information is conditionally |
| | | | mandatory if there are HOA |
| | | | sources belonging to more than |
| | | | one group in the MPD. |
| Neighbor_HOA_Sources.List. | O | xs:string | List of hoa_source_id |
| | | | corresponding to the HOA |
| | | | sources which are needed to |
| | | | cover the neighboring regions. |
| | | | This information is optional. It is |
| | | | provided by the content creator to |
| | | | faciliate the rendering device to |
| | | | retrieve relevant content in |
| | | | anticipation of its utility in case of |
| | | | listener movement into different |
| | | | subspaces or in case of |
| | | | teleportation (i.e. sudden |
| | | | movement). |

If the adaptation set contains N HOA sources list, the list of HOA sources describe the relevant HOA sources for a subspace within the listening space. In some examples the listening space need not be defined and so the N HOA sources in the adaptation set could describe a subspace within the available space. The subspace can be a line, a two dimensional area or a volume. In some examples, the list of HOA sources can describe a larger region of listening space.

If the adaptation set contains a single HOA source, the client can determine the relevant HOA sources for a given listener position based on information from the 6DOFRetrievalStruct( ) described above, which can be delivered as a separate file using a suitable mechanism such as a URL or derived by the client. The information can be retrieved as a 6DOF Retrieval timed metadata track as described below or in any other suitable format

If the adaptation set contains only a single HOA source the Neighbor_HOA_Sources. List can indicate HOA sources needed to cover neighbouring regions. The neighbouring regions could be neighbouring subspaces or parts of the neighbouring subspaces. In such cases a plurality of HOA sources can be retrieved for rendering a position within the subspace even though only a single HOA source is associated with the subspace itself.

Where single HOA source comprises media tracks, an MPEG-H 3DA defined MHAS packet PACTYP_MPEGH3DAFRAME can be used. In such cases the rendering device needs to obtain three packets separately before being able to render the audio scene. This can be achieved by preceding a new packet PACTYP_MPEGH3DA6DOFHOA (in the delivered stream) ahead of the corresponding HOA source related PACTYP_MPEGH3DAFRAME packets.

In another example, a new packet PACTYP_MPEGH6DOFHOAFRAME can be used. Such packets can be used in examples where each of the HOA sources are arranged in such a way that they are available to the rendering device in a ready to use format. The audio data can be formatted such that the samples from all the HOA sources are interleaved for direct ingestion by the rendering device.

As an example embodiment, HOA source content for all the HOA sources for a given subspace is packed in such a manner that the audio data and rendering metadata is delivered in the same segment. In other embodiments, the audio data and rendering metadata are different media tracks with individual adaptation sets.

In another example all of the HOA sources can be packed in a MPEG-H compatible HOAFrame( ) for easier interoperability. In such examples the following data structure can be used:

```
aligned (8) 6DOFHOAFrame ( ) {
  unsigned int (8) num_hoa_sources; //number of HOA sources
in a frame
  for (i = 0; i < num_hoa_sources; j++) {
    HOAFrame ( ) ;//As defined in 12.2.2 clause in MPEG-H
3DA
  }
}
```

In some examples the HOA group identifier can be indicated together with each HOA source. In examples where the 6DOFRetrievalStruct( ) comprises time varying information it can be delivered as a timed metadata track. The 6DOFRetrievalStruct( ) can be implemented as an additional box for the file comprising the HOA sources audio signal data and the associated rendering metadata. In such examples the following data structure can be used:

```
class 6DOFHOARetrievalSampleEntry ( ) extends
MetaDataSampleEntry ( ′ 6dhr′) {
    6DOFHOARetreivalInfoBox ( ) ; // mandatory
}
class 6DOFHOARetrievalInfoBox extends FullBox ( ′6dhi′,
version, 0) {
  unsigned int (32) num_subspaces ;
  for (m = 0; m < num_subpaces; m++) {
    6DOFSubspaceRetrievalStruct ( ) ;
  }
}
```

In the file formal level, each HOA source audio signal data and associated rendering metadata track can be referenced by a ‘cdsc’ track reference from a 6DOF HOA retrieval timed metadata track. The group of audio tracks that correspond to the subset of HOA sources associated with a position or subspace of the listening space 201 can be reference by a ‘cdtg’ track reference from the 6DOF HOA retrieval timed metadata track.

In the DASH MPD level the 6DOF HOA retrieval timed metadata track can comprise a representation in an adaptation set that associates all the HOA sources with a position or subspace of the listening space 201. In such examples the associationType=‘cdsc’ and codecs=‘6dsr’. The following data structure can be used in such examples:

```
<AdaptationSet segmentAlignment=″true″
subsegmentAlignment=″true″ subsegmentStartsWithSAP=″1″>
  <Representation id=″6DOFHOARetrievalTrack″
mimeType=′application/mp4′ associationId=″hoa_source_1,
hoa_source_2, hoa_source_3″ associationType=″cdsc″
codecs=″6dsr″ bandwidth=″100″>
    <BaseURL>6DOF_HOA_Retrieval.mp4</BaseURL>
  </Representation>
</AdaptationSet>
```

In some examples the 6DOF HOA retrieval timed metadata track can be implemented as a base track for 6DOF HOA rendering with one base track for each subset of HOA sources. The HOA base track adaptation set comprises the Preselection descriptor and a list of other adaptation sets. The list of other adaptation sets comprises all of the available HOA source adaptation sets. The HOA base track adaptation set is provided for each subset of HOA sources associated with given positions or sources within the listening space 201. The HOA base track adaptation set can be described with a new EssentialProperty or SupplementalProperty with schemeldUri “urn:mpeg:mpegl:6dofAudio:2020:6hgb” The @value is equal to hoa_source_group_id or the group ID for the subset of HOA sources. The base 6DOFRetrivalTrack adaptation set also has a preselection that comprises a list of AdaptationSets IDs comprising the HOA sources in the HOA subset (equal to @value of ‘6hgb’) which can be rendered together. The HOA subsets can include single HOA source adaptation subsets as well as multiple HOA source packed adaptation sets. An example data structure is given below. In this example an adaptation set with ID=3000 is the base 6DOF retrieval information carry data. The other Adaptation sets carry HOA sources with IDs 1, 2, 3 and 4. These are included in the preselection in the ‘6hgb’ adaptation set.

```
  <AdaptationSet id=″3000″ mimeType=″audio/mp4″
  profiles=″oabl″ codecs=″mhm2.XXXX″ segmentAlignment=″1″>
    <EssentialProperty
  schemeIdUri=″urn:mpeg:mpegI:6dofAudio:2020:6hgb″
  omaf: projection_type=″0″/>
  <SupplementalProperty
  schemeIdUri=″urn:mpeg:dash:preselection:2016″
  value=″1,2, ″/>
  </AdaptationSet>
  <AdaptationSet id=″4000″ mimeType=″audio/mp4″
  profiles=″oabl″ codecs=″mhm2.XXXX″ segmentAlignment=″1″>
    <6DoFHOASource
  schemeIdUri=″urn:mpeg:mpegI:6dofAudio:2020:6dho″
  value=″1″>
      <HOASourcePosition_Source_Position_X=″1″
  Source_Position_Y=″2″ Source_Position_Z=″3″/>
      <HOASourceGroupInfo groupId=″0″/>
      <Neighbor_HOA_Sources List=″2, 3, 4″/>
    </6DoFHOASource>
  </AdaptationSet>
  <AdaptationSet id=″5000″ mimeType=″audio/mp4″
  profiles=″oabl″ codecs=″mhm2.XXXX″ segmentAlignment=″1″>
    <6DoFHOASource
  schemeIdUri=″urn:mpeg:mpegI:6dofAudio:2020:6dho″
  value=″2″>
      <HOASourcePosition Source_Position_X=″1″
  Source_Position_Y=″2″ Source_Position_Z=″3″/>
      <HOASourceGroupInfo groupId=″0″/>
      <Neighbor_HOA_Sources List=″1, 3, 4″/>
  </6DoFHOASource>
  </AdaptationSet>
  <AdaptationSet id=″6000″ mimeType=″audio/mp4″
  profiles=″oabl″ codecs=″mhm2.XXXX″ segmentAlignment=″1″>
  <6DoFHOASource
  schemeIdUri=″urn:mpeg:mpegI:6dofAudio:2020:6dho″
  value=″3″>
      <HOASourcePosition Source_Position_X=″1″
  Source_Position_Y=″2″ Source_Position_Z=″3″/>
      <HOASourceGroupInfo groupId=″0″/>
      <Neighbor_HOA_Sources List=″1, 3,4″/>
  </6DoFHOASource>
  </AdaptationSet>
<AdaptationSet id=″7000″ mimeType=″audio/mp4″ profiles=″oabl″
codecs=″mhm2.XXXX″ segmentAlignment=″1″>
  < 6DoFHOASource
scheme IdUri=″urn:mpeg:mpegI:6dofAudio:2020:6dho″ value=″4″>
```

| | |
|---|---|
| <HOASourcePosition | Source_Position_X=″1″ |

```
Source_Position_Y=″2″ Source_Position_Z=″3″/>
    <HOASourceGroupInfo groupId=″0″/>
    <Neighbor_HOA_Sources List=″1, 3, 4″/>
  </ 6DoFHOASource>
</AdaptationSet>
```

FIGS. 10A and 10B schematically show the retrieval and rendering of audio content in some examples of the disclosure.

FIG. 10A shows an example DASH based retrieval and rendering flow. In the example of FIG. 10A a DASH MPD is created by a DASH server device 1001. To obtain the DASH MPD the DASH server device 1001 forms adaptation sets 1005 comprising HOA source audio data and the associated rendering metadata. In the example shown in FIG. 10A an adaptation set 1005 is provided for each of the available HOA sources.

The DASH MPD declares the available HOA sources in a group 1003 for 6DOF rendering. In the example of FIG. 10A each of the groups 1003 comprises N adaptation sets 1005 so that each HOA source within the listening space 201 is represented within the group. In these examples N can be any positive integer. In the example of FIG. 10A two groups 1003 are provided. It is to be appreciated that any number of groups could be provided in other examples of the disclosure.

The groups 1003 that are declared in the DASH MPD also comprise a 6DOF retrieval track 1007. The 6DOF retrieval track 1007 comprises metadata that provides information that enables the retrieval of the HOA sources. The 6DOF retrieval track 1007 can comprise information that indicates which HOA sources are associated with given positions or subspaces within a listening space 201. This information could be obtained using the method of FIG. 1 or any other suitable method. The process of associating the HOA sources with a position or subspace could be performed by the DASH server 1001 or by any other suitable device.

The DASH MPD can be provided to the DASH client 1021 via HTTP (Hypertext Transfer Protocol) or using any other suitable protocol. The DASH client 1021 can be provided in a rendering device or any other suitable device.

The DASH client 1021 accesses 1009 the DASH MPD to obtain the list of available HOA sources and the 6DOF retrieval track 1007. The DASH client 1021 uses the DASH MPD to retrieve 1011 the metadata in the 6DOF retrieval track 1007.

The DASH client 1021 obtains 1013 information relating to the current position and orientation of the listener 205 within the listening space 201. The DASH client 1021 uses the information relating to the listener position and the 6DOF retrieval track 1007 to determine 1015 the HOA sources that are associated with the current position of the listener 205.

Once the HOA sources that are associated with the current position of the listener 205 have been determined the DASH client 1021 retrieves 1017 the relevant HOA sources and then enables the audio signals to be rendered 1019 using the retrieved HOA sources. As the HOA sources associated with a position or subspace are identified in the DASH MPD the client device 1021 only needs to retrieve those HOA sources. This reduces the data that needs to be delivered to the DASH client 1021 and can also reduce the computation requirements for the DASH client 1021.

FIG. 10B shows another example DASH based retrieval and rendering flow which is similar to the example shown in FIG. 10A. However in the example of FIG. 10B a plurality of HOA sources can be provided in each adaptation set 1005. In this example each of the adaptation sets 1005 comprises HOA sources that are sufficient to enable at least one subspace or position within a listening space 201 to be rendered. In the example shown in FIG. 10B each of the adaptation sets 1005 comprises a different subset of the available HOA sources.

The DASH MPD declares the available HOA sources in a group 1003 for 6DOF rendering. In the example of FIG. 10B only one group is provided because each of the adaptation sets 1005 comprises HOA sources that are sufficient to enable at least one subspace or position within a listening space 201 to be rendered.

The group 1003 that is declared in the DASH MPD also comprises a 6DOF retrieval track 1007. The 6DOF retrieval track 1007 comprises metadata that provides information that enables the retrieval of the HOA sources. The 6DOF retrieval track 1007 can comprise information that indicates which HOA sources are associated with given positions or subspaces within a listening space 201. This information could be obtained using the method of FIG. 1 or any other suitable method.

The DASH MPD is then provided to the DASH client 1021 via HTTP (Hypertext Transfer Protocol) or using any other suitable protocol where the DASH client uses the DASH MPD to enable audio rendering using the method shown in FIG. 10A and described above.

In the examples shown in FIGS. 10A and 10B the DASH client 1021 can be configured to retrieve the “6DOF retrieval information” for a time period that is longer than the duration of the information relating to the HOA sources. This enables the DASH client 1021 to prefetch content such as HOA source audio data if there is a likelihood that the listener 205 could make a quick or sudden change in position within the listening space 201.

FIG. 11 shows another example DASH based retrieval and rendering flow. In this example the associating of the HOA sources with positions or subspaces within a listening space can be performed by the DASH client 1021 instead of the DASH server 1001.

In the example of FIG. 11 the DASH server device 1001 forms adaptation sets 1005 comprising HOA source audio data and the associated rendering metadata. An adaptation set 1005 can be provided for each of the available HOA sources. The DASH MPD declares the available HOA sources in a group 1003 for 6DOF rendering. The group 1003 comprises N adaptation sets 1005 so that each HOA source within the listening space 201 is represented within the group.

It is to be noted that in the example of FIG. 11 the groups 1003 that are declared in the DASH MPD do not comprise a 6DOF retrieval track 1007 because the associating of the HOA sources with positions or subspaces within a listening space is performed by the DASH client 1021 instead of the DASH server 1001.

In some examples the DASH client 121 can be configured to retrieve the HOA source positions as well as the HOA rendering metadata for one or more areas close to the current listener position. The areas can be the areas surrounding the current listener position, areas contiguous with the current listener position or any other suitable areas. This enables the DASH client to have awareness of the HOA sources around the current listener position and a better understanding of the audio scenes around the current listener position and can be used if the current listener position changes.

The rendering metadata for each HOA source can be separated so that the DASH client 121 can retrieve the HOA rendering metadata without retrieving the HOA audio data. The rendering metadata can be organized for larger subspaces that covers areas surrounding determined positions within the listening space. This can enable a DASH client 121 to retrieve the metadata for a larger number of HOA sources than the audio data is retrieved for. For instance, the DASH client 121 can retrieve the audio signals for three HOA sources and the spatial metadata for six HOA sources. This can be achieved for adaptation sets where the audio data and the spatial metadata are disjoint thus permitting differentiated retrieval.

In some examples a 6DOF retrieval track 1007 can comprise separate information for metadata retrieval. This information can comprise information relating to the larger subspaces or the regions adjacent to the subspaces for which the additional rendering metadata should be obtained. In some examples a plurality of different versions or representations of the 6DOF retrieval track 1007 can be provided where metadata retrieval subspaces are defined according to per subspace bitrate. This can enable the client to choose the appropriate representation. The retrieval subspaces with the greater bitrate and/or corresponding subspace region provide the client with awareness about a larger region around the current listener position.

This can be useful as the additional spatial metadata can improve the quality of the audio rendering while only requiring a small increase in bandwidth because the bandwidth of the spatial metadata may be significantly smaller than the bandwidth of the audio signals.

In some examples there might not be any spatial metadata retrieved by the DASH client 121. In such examples the spatial metadata could be estimated from the HOA audio signals or the spatial rendering could be implemented using a method that does not require spatial metadata.

The DASH MPD can be provided to the DASH client 1021 via HTTP (Hypertext Transfer Protocol) or using any other suitable protocol. The DASH client 1021 can be provided in a rendering device or any other suitable device.

The DASH client 1021 accesses 1101 the DASH MPD to obtain the list of available HOA sources and information relating to the HOA source positions, rendering metadata and the audio data.

The DASH client 1021 uses the information in the DASH MPD to retrieve 1103 the HOA source position information. This provides information about the position of the HOA sources within the listening space 201.

The DASH client 1021 obtains 1105 information relating to the current position and orientation of the listener 205 within the listening space 201. The DASH client 1021 uses the information relating to the listener position and the HOA source position information to determine 1107 which HOA sources are associated with the current listener position and orientation. This can be done by associating one or more HOA sources with the current listener position and orientation as shown in FIG. 1 and described above.

Once the HOA sources that are associated with the current position of the listener 205 have been determined the DASH client 1021 retrieves 1109 the relevant HOA source audio and rendering metadata and then enables the audio signals to be rendered 1111 using the retrieved HOA sources. As the DASH client has determined the HOA sources associated with a position or subspace the client device 1021 only needs to retrieve those HOA sources. This reduces the data that needs to be delivered to the DASH client 1021 and can also reduce the computation requirements for the DASH client 1021.

In some exampled the DASH client 1021 can retrieve HOA source audio data and rendering metadata that covers an area beyond the current subspace of the listener 205. This can provide the DASH client 1021 with an awareness of the area surrounding the listener 205 and can help to prepare the DASH client 1021 for any movements of the listener 205 into those surrounding areas.

In examples where the listening space is unconstrained, the DASH client 121 can retrieve HOA sources in proximity to the current listener position to determine the optimal subset. Subsequently, the DASH client 121 can determine, the appropriate distance beyond which, the rendering should be stopped if the audio quality is below the desired quality level. The appropriate distance can be determined with distance based attenuation or any other suitable means.

FIG. 12 shows a system 1201 that can be used to implement examples of the disclosure. The system 1201 comprises an authoring and encoding process 1203, a declaration and format process 1205, a retrieval process 1207 and a playback process 1209.

The authoring and encoding process 1203 can be provided in a DASH server, an audio capture device or any other suitable type of device.

The authoring and encoding process 1203 obtains information 1211 relating to the listening space 201. In the example shown in FIG. 12 the authoring and encoding process 1203 obtains listening space information, an encoder input format and any other suitable information.

The authoring and encoding process 1203 is also configured to obtain the HOA source audio data 1213. The HOA source audio data can comprise audio signal sets that enable rendering of the audio scenes of the listening space 201. The source audio data is obtained for N HOA sources where N is the number of HOA sources in the listening space. The HOA source audio data can also comprise information about the order of HOA sources.

The authoring and encoding process 1203 uses the obtained HOA source audio data 1213 and the information 1211 relating to the listening space to perform processing 1215 to derive information for the efficient 6DOF retrieval. This processing can comprise associating one or more HOA sources with determined positions of the listening space 201 as described above. The authoring and encoding process 1203 can also use this information to obtain the rendering spatial metadata that enables the spatial aspects of the listening space 201 to be recreated for the listener 205.

In some examples the authoring and encoding process 1203 can also compress the audio content and any other data that needs to be transmitted. Any suitable process can be used for the encoding.

The declaration and format process 1205 is configured to use the information provided by the authoring and encoding process 1203 to create a representation of the data that enables efficient retrieval of the required HOA sources.

The declaration and format process 1205 uses the rendering metadata from the authoring and encoding process 1203 to format and pack 1223 the HOA source data into bundles with the relevant rendering metadata to enable efficient retrieval of the HOA source data with the correct rendering metadata. This ensures that when a rendering device retrieves a subset of HOA sources they also only need to retrieve the relevant rendering metadata. The HOA source data is provided as DASH segments 1229.

The declaration and format process 1205 also uses the information to provide 1221 a HOA declaration which comprises information indicating the HOA sources associated with the positions or subspaces within the listening space 201. In the example of FIG. 12 the content declaration and format is shown in conjunction with MPEG DASH delivery. It is to be appreciated that other retrieval architectures such as HLS, CMAF could be used in other examples of the disclosure. The HOA declaration is provided to a DASH manifest 1227.

The retrieval process 1207 is configured to select content for rendering and enable the selected content to be retrieved. The retrieval process 1207 can be implemented using a listener app 1225 that can be provided within a rendering device. The listener app 1225 is configured to request and retrieve data from the DASH manifest 1227 and the DASH segments 1229.

The listener app 1225 comprises listener application and adaptation logic 1231. In the retrieval process 1207 the listener application and adaptation logic 1231 obtains information from a 6DOF tracker 1233. This information can provide information about the current position and orientation of a listener 205. This can be a virtual position in a virtual environment or a real position that can be mapped into a virtual environment or any other suitable position.

The listener app 1225 performs content selection 1235. The content selection comprises determining which HOA sources are needed based on the current position of the listener 205. To perform content selection 1235 the listener app 1225 can access the DASH manifest to determine which HOA sources are associated with the current position of the listener 205.

Once the HOA sources that are needed have been identified the listener app 1225 performs content retrieval 1237. The listener app 1225 accesses the DASH segments 1229 to retrieve the audio data and rendering metadata associated with the HOA sources that are associated with the current position of the listener 205. The listener app 1225 can perform any necessary parsing and decoding on the content that is retrieved.

The listener app 1225 then enables the rendering 1239 of the retrieved content to provide the playback process 1209. The retrieve content is rendered so as to enable 6DOF movement of the listener 205 within the listening space 201.

FIG. 13 schematically illustrates an apparatus 1301 according to examples of the disclosure. The apparatus 1301 illustrated in FIG. 13 could be a chip or a chip-set. In some examples the apparatus 1301 can be provided within devices such as an audio capturing devices or audio rendering devices. The apparatus 1301 can be provided within a system 1201 as shown in FIG. 12.

In the example of FIG. 13 the apparatus 1301 comprises a controller 1303. In the example of FIG. 13 the implementation of the controller 1303 can be as controller circuitry. In some examples the controller 1303 can be implemented in hardware alone, have certain aspects in software including firmware alone or can be a combination of hardware and software (including firmware).

As illustrated in FIG. 13 the controller 1303 can be implemented using instructions that enable hardware functionality, for example, by using executable instructions of a computer program 1309 in a general-purpose or special-purpose processor 1305 that can be stored on a computer readable storage medium (disk, memory etc.) to be executed by such a processor 1305.

The processor 1305 is configured to read from and write to the memory 1307. The processor 1305 can also comprise an output interface via which data and/or commands are output by the processor 1305 and an input interface via which data and/or commands are input to the processor 1305.

The memory 1307 is configured to store a computer program 1309 comprising computer program instructions (computer program code 1311) that controls the operation of the apparatus 1301 when loaded into the processor 1305. The computer program instructions, of the computer program 1309, provide the logic and routines that enables the apparatus 1301 to perform methods such as the method illustrated in FIG. 1. The processor 1305 by reading the memory 1307 is able to load and execute the computer program 1309.

The apparatus 1301 therefore comprises means for: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener if the listener is at the first position the first subset of audio signal content sets is retrieved and if the listener is at the second position the second subset of audio signal content sets is retrieved. This can enable the disclosure to be implemented in an encoding device. This can enable the disclosure to be implemented in an encoding device.

In some examples the apparatus 1301 comprises means for obtaining information declaring available audio signal content sets that provide one or more spatial audio scenes; determining a plurality of positions in which the one or more spatial audio scenes are audible to a listener; associating a subset of audio signal content sets with the determined plurality of positions such that a first subset of audio signal content sets is associated with a first position and a second subset of audio signal content sets is associated with a second position; and retrieving audio content for rendering such that if the listener is at the first position the first subset of audio signal content sets is retrieved and if the listener is at the second position the second subset of audio signal content sets is retrieved. This can enable the disclosure to be implemented in a decoding device.

As illustrated in FIG. 13 the computer program 1309 can arrive at the apparatus 1301 via any suitable delivery mechanism 1313. The delivery mechanism 1313 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 1309. The delivery mechanism can be a signal configured to reliably transfer the computer program 1309. The apparatus 1301 can propagate or transmit the computer program 1309 as a computer data signal. In some examples the computer program 1309 can be transmitted to the apparatus 701 using a wireless protocol such as Bluetooth, Bluetooth Low Energy, Bluetooth Smart, 6LoWPan (IPv6 over low power personal area networks) ZigBee, ANT+, near field communication (NFC), Radio frequency identification, wireless local area network (wireless LAN) or any other suitable protocol.

The computer program 1309 comprises computer program instructions for causing an apparatus 1301 to perform at least the following: generating audio signal content sets that provide one or more spatial audio scenes; determining a plurality of positions in which the one or more spatial audio scenes are audible to a listener; and associating a subset of audio signal content sets with the determined plurality of positions such that a first subset of audio signal content sets is associated with a first position and a second subset of audio signal content sets is associated with a second position and wherein the association is such that when audio signal content is provided for rendering to a listener if the listener is at the first position the first subset of audio signal content sets is retrieved and if the listener is at the second position the second subset of audio signal content sets is retrieved. This can enable the disclosure to be implemented in an encoding device.

In some examples the computer program 1309 comprises computer program instructions for causing an apparatus 1301 to perform at least the following: obtaining information declaring available audio signal content sets that provide one or more spatial audio scenes; determining a plurality of positions in which the one or more spatial audio scenes are audible to a listener; associating a subset of audio signal content sets with the determined plurality of positions such that a first subset of audio signal content sets is associated with a first position and a second subset of audio signal content sets is associated with a second position; and retrieving audio content for rendering such that if the listener is at the first position the first subset of audio signal content sets is retrieved and if the listener is at the second position the second subset of audio signal content sets is retrieved. This can enable the disclosure to be implemented in a decoding device.

The computer program instructions can be comprised in a computer program 1309, a non-transitory computer readable medium, a computer program product, a machine readable medium. In some but not necessarily all examples, the computer program instructions can be distributed over more than one computer program 1309.

Although the memory 1307 is illustrated as a single component/circuitry it can be implemented as one or more separate components/circuitry some or all of which can be integrated/removable and/or can provide permanent/semi-permanent/dynamic/cached storage.

Although the processor 1305 is illustrated as a single component/circuitry it can be implemented as one or more separate components/circuitry some or all of which can be integrated/removable. The processor 1305 can be a single core or multi-core processor.

References to “computer-readable storage medium”, “computer program product”, “tangibly embodied computer program” etc. or a “controller”, “computer”, “processor” etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” can refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The recording of data such as audio signals or manifests associating subsets of HOA sources with a position can comprise only temporary recording, or it can comprise permanent recording or it can comprise both temporary recording and permanent recording. Temporary recording implies the recording of data temporarily. This can, for example, occur during sensing or image capture, occur at a dynamic memory, occur at a buffer such as a circular buffer, a register, a cache or similar. Permanent recording implies that the data is in the form of an addressable data structure that is retrievable from an addressable memory space and can therefore be stored and retrieved until deleted or over-written, although long-term storage may or may not occur. The use of the term ‘capture’ in relation to audio signals relates to temporary recording of the data of the image. The use of the term ‘store’ in relation to an image relates to permanent recording of the data of the audio signals.

The above described examples find application as enabling components of:
automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. An apparatus, comprising:
at least one processor; and
at least one non-transitory memory storing instructions that, when executed with the at least one processor, cause the apparatus to:
generate audio signal content sets that provide one or more spatial audio scenes;
determine a plurality of positions in which the one or more spatial audio scenes are audible to a listener, wherein the instructions are caused to enable six degrees of freedom of movement of the listener; and
associate a first subset of audio signal content sets with a first position and a second subset of audio signal content sets with a second position, wherein the first subset is provided for rendering to the listener when the listener is at the first position when the first subset of audio signal content sets is retrieved and the second subset is provided for rendering when the listener is at the second position when the second subset of audio signal content sets is retrieved.

2. An apparatus as claimed in claim 1, wherein the audio signal content sets comprise at least one of:
two or more audio channels; or
one or more audio channels and metadata corresponding to the one or more audio channels.

3. An apparatus as claimed in claim 2, wherein the instructions, when executed with the at least one processor, provide the audio signal content sets in data structures comprising the audio channel data and associated rendering metadata.

4. An apparatus as claimed in claim 3, wherein a plurality of data structures is provided in a track grouping with metadata associating the data structures to one or more determined positions.

5. An apparatus as claimed in claim 1, wherein when the listener is in the first position, audio signal content sets that are not within the first subset of audio signal content sets are not retrieved and when the listener is in the second position audio signal content sets that are not within the second subset of audio signal content sets are not retrieved.

6. An apparatus as claimed in claim 1, wherein the subsets of audio signal content sets cover a plurality of areas within which the listener moves, and the size of the areas covered with the subsets of audio signal content sets is determined with one or more factors comprising speed of movement of the listener.

7. An apparatus as claimed in claim 6, wherein the size of areas covered with one or more subsets of audio signal content sets is configured to change so that different sized areas are covered at different times.

8. An apparatus as claimed in claim 1, wherein the audio signal content sets comprise higher order ambisonic source data, and wherein the higher order ambisonic source data comprises one or more sets of multi-channel audio signals or one or more sets of metadata.

9. An apparatus as claimed in claim 1, wherein the subset of audio signal content sets that are associated with a position comprise at least one of:
audio signal content sets that enable rendering of the spatial audio scene with a predetermined quality level; or
audio signal content sets that enable rendering of spatial audio scenes at listener positions close to the determined position.

10. (canceled)

11. An apparatus as claimed in claim 1, wherein the instructions, when executed with the at least one processor, cause the apparatus to determine the plurality of positions with dividing the listening space into a plurality of subspaces such that a subset of audio signal content sets is associated with a subspace.

12. An apparatus as claimed in claim 1, wherein the instructions, when executed with the at least one processor, cause the apparatus to at least one of:
create a manifest storing the associations between the positions and the subsets of audio signal content sets; or
enable the manifest to be accessed with a rendering device.

13. An apparatus as claimed in claim 1, wherein the instructions, when executed with eh at least one processor, cause the apparatus to provide the audio signal content sets in an adaptation set comprising a plurality of audio signal content sets and metadata associating the audio signal content sets with one or more positions.

14. A method for six degrees of freedom rendering, comprising:
generating audio signal content sets that provide one or more spatial audio scenes;
determining a plurality of positions in which the one or more spatial audio scenes are audible to a listener, wherein six degrees of freedom of movement is enabled; and
associating a first subset of audio signal content sets with a first position and a second subset of audio signal content sets with a second position, wherein the first subset is provided for rendering to the listener when the listener is at the first position when the first subset of audio signal content sets is retrieved and the second subset is provided for rendering when the listener is at the second position when the second subset of audio signal content sets is retrieved.

15-22. (canceled)

23. A method as claimed in claim 14, wherein the audio signal content sets comprise at least one of:
two or more audio channels; or
one or more audio channels and metadata corresponding to the one or more audio channels.

24. A method as claimed in claim 14, wherein the audio signal content sets are configured to be provided in data structures comprising the audio channel data and associated rendering metadata.

25. A method as claimed in claim 14, wherein a plurality of data structures is provided in a track grouping with metadata associating the data structures to one or more determined positions.

26. An apparatus, comprising:
at least one processor; and
at least one non-transitory memory storing instructions that, when executed with the at least one processor, cause the apparatus at least to:
obtain information declaring available audio signal content sets that provide one or more spatial audio scenes;
determine a plurality of positions in which the one or more spatial audio scenes are audible to a listener, wherein six degrees of freedom of movement is enabled;
associate a subset of audio signal content sets with the determined plurality of positions such that a first subset of audio signal content sets is associated with a first position and a second subset of audio signal content sets is associated with a second position; and
retrieve audio signal content for rendering such that when the listener is at the first position the first subset of audio signal content sets is retrieved and when the listener is at the second position the second subset of audio signal content sets is retrieved.

27. An apparatus as claimed in claim 26, wherein when the audio signal content is provided for rendering to the listener, the audio signal content that is retrieved is restricted to the subset of audio signal content sets that is associated with the position of the listener.

28. A method for six degrees of freedom rendering, comprising:
obtaining information declaring available audio signal content sets that provide one or more spatial audio scenes;
determining a plurality of positions in which the one or more spatial audio scenes are audible to a listener, wherein six degrees of freedom of movement is enabled;
associating a subset of audio signal content sets with the determined plurality of positions such that a first subset of audio signal content sets is associated with a first position and a second subset of audio signal content sets is associated with a second position; and
retrieving audio content for rendering such that when the listener is at the first position the first subset of audio signal content sets is retrieved and when the listener is at the second position the second subset of audio signal content sets is retrieved.

29. A method as claimed in claim 28, wherein when the audio signal content is provided for rendering to the listener, the audio signal content that is retrieved is restricted to the subset of audio signal content sets that is associated with the position of the listener.

30. A non-transitory program storage device readable with an apparatus, tangibly embodying a program of instructions executable with the apparatus for performing the method of claim 14.

31. A non-transitory program storage device readable with an apparatus, tangibly embodying a program of instructions executable with the apparatus for performing the method of claim 28.
